(19) United States
(12) Patent Application Publication
(10) Pub. No.: US 2005/0216839 A1
(43) Pub. Date: Sep. 29, 2005

(54) Audio scrubbing

(76) Inventor: Keith Salvucci, Belmont, CA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/809,257

(22) Filed: Mar. 25, 2004

(51) Int. Cl. G11B 27/00

(52) U.S. Cl. 715/723; 715/716; 715/719

(57) ABSTRACT

The present invention relates to a graphical user interface. More particularly, the present invention relates to a graphical user interface for media file editing software designed to be used on a general purpose computer. The interface provides improved features for locating a point of interest with in the media file based on an audible portion of the file.

### BACKGROUND

The invention relates generally to video editing software, and more particularly to a graphical user interface for video editing software. Historically editing of video images has been limited to professional production companies using extremely expensive equipment. This was in part because the significant computational power necessary to perform editing of video images has been prohibitively expensive for the consumer market. Because the market for video editing equipment, e.g., video editing software, has been comprised almost entirely of professionals, it has historically been very feature rich, but also encumbered with correspondingly sophisticated user interfaces.

Recently, innovations in computing power of personal computers has combined with reduced costs for such systems and availability of consumer-grade digital video cameras to put professional-grade video editing within the capability of consumer-oriented personal computers and relatively inexpensive hardware/software combinations. Although the computational power necessary to perform video editing has been made available to the consumer, the historic problems with excessive user interface complexity has prevented wide-spread adoption of video editing hardware and software for the personal computer targeted at the consumer market. Thus, it would be beneficial to provide video editing software and/or a video editing software hardware combination with a greatly simplified user interface to enable a typical consumer to produce professional-grade video using inexpensive, general-purpose computers.

### SUMMARY

The present invention relates to a graphical user interface. More particularly, the present invention relates to a graphical user interface for media file editing software designed to be used on a general purpose computer. The interface provides improved features for locating a point of interest with in the media file based on an audible portion of the file.

In particular, a graphical user interface provides a scrubber bar, which iconographically illustrates a time axis of the media file. The graphical user interface further comprises a play head indicating a current temporal location of the media being displayed and/or audibly broadcast at that point in the media file. By clicking and dragging a playhead along a scrubber bar, the user may hear an accelerated playback of the audio portion of the media file. The speed of the playback preferably varies as a function of the displacement between the playhead and cursor, i.e., the rate at which the playhead is dragged along the scrubber bar.

### BRIEF DESCRIPTION OF THE DRAWINGS

FIG. 1a illustrates creation of an audio/video media file.

FIG. 1b illustrates the transfer of an audio/video media file to a personal computer.

FIG. 2A illustrates a graphical user interface for a media file editing program in accordance with the teachings of the present disclosure.

FIG. 2B illustrates an enlarged view of a portion of the user interface of FIG. 2A.

### DETAILED DESCRIPTION

A graphical user interface to a video editing software program for use on a general purpose personal computer is described herein. The following embodiments of the invention, described in terms applications compatible with computer systems manufactured by Apple Computer, Inc. of Cupertino, Calif., are illustrative only and should not be considered limiting in any respect. Additionally, while the invention is described with regard to a video editing, it is applicable to any type of media editing, including video files, audio files, and audio-video files. As used herein, the term media should be understood to include each of these types of files and their equivalents.

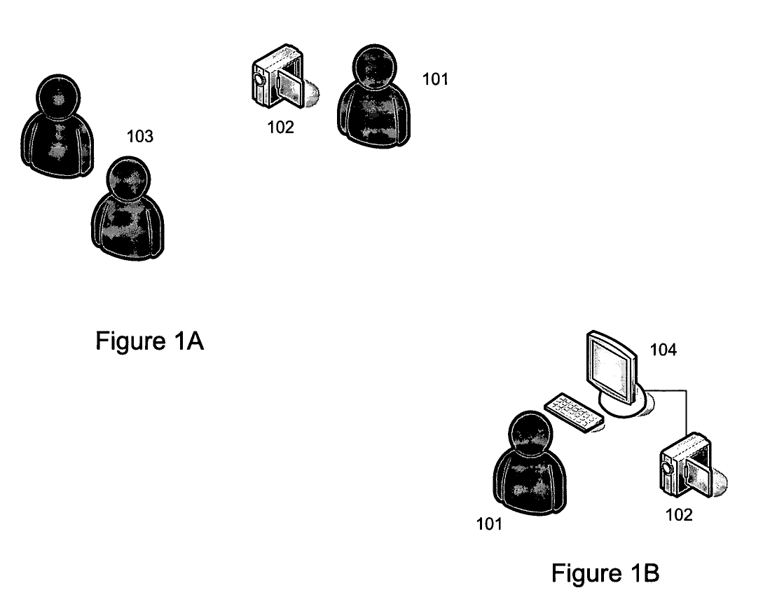

With reference FIG. 1A, a user 101 uses a video camera 102 to record video images of a scene 103. Video camera 102 may be any type of video camera, although it is preferably a consumer-oriented video camera and more preferably a consumer-oriented video camera that records images in a digital format. Subsequently, as indicated in FIG. 1B, user 101 connects the video camera 102 to a personal computer 104 for the purpose of transferring the recorded video images from the video camera to the personal computer. Personal computer 104 is preferably one of various types manufactured by Apple Computer, Inc., although the graphical user interface described herein may be used with other computer types. If video camera 102 is a type that records images in a digital format, and it is equipped with an output port compatible with an input port on the computer, e.g., IEEE 1394 a/k/a “Firewire”, the video data may be transferred to the computer exactly as recorded. Alternatively, if video camera 102 records images in one of various traditional analog formats, e.g., VHS or its derivatives, personal computer 104 may be equipped with some sort of video capture device, for example a video capture peripheral card, that will capture the video data from the camera and store it on the computer in a digital format suitable for further processing by the computer. Various techniques and devices for transferring video images from a video camera to a computer are known to those skilled in the art, and it is contemplated that any of them may be used in accordance with the system described herein.

Once loaded on the personal computer, recorded video may be edited, stored on the computers hard disk drive, or copied to another medium for storage or for replay on another device. Media to which the video may be copied include, for example, digital versatile disk (DVD) or video compact disk (VCD or SVCD). Additionally, combinations are also contemplated, e.g., the video may be edited on the personal computer and the edited video may then be copied to a DVD for storage and replay on another device.

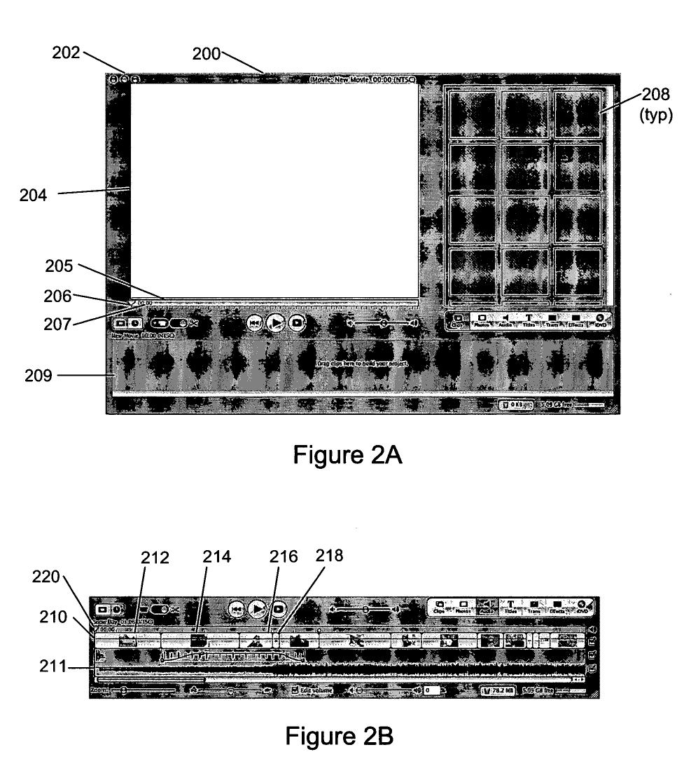

Turning now to FIG. 2, a screen shot from video editing software in accordance with the present invention is illustrated. Main window 200 comprises the visual portion of the user interface to the video editing software. As typically found in computer systems having graphical user interfaces, window control “buttons” 202 allow the user to maximize, minimize, or close main window 200. A composition window or monitor 204 is used to view the current video composition, i.e. the product of the video editing process. A scrubber bar 205 allows the user to move through a clip or composition, either frame by frame or on a faster basis. Such operation is preferably accomplished by a “click-and-drag” operation. Playhead 206 indicates the location of the currently displayed image within the composition, both by its relative left-to-right position on the scrubber bar 205 and by the numerical time readout 207 located adjacent the playhead.

A video composition is comprised of video clips, which would be shown in individual windows 208. Although the clip windows 208 in FIG. 2A are shown empty, for convenience, video clips will also be referred to using reference 208. A video clip is a sequence of video (and corresponding audio) data, for example, a sequence transferred from the video camera. A composition may include from one to any number of individual video clips, although typically the composition will include multiple clips. Video clips 208 may be combined sequentially to form the composition by placing them in the desired order in timeline 210 (FIG. 2B), which may preferably be accomplished by a “drag and drop” operation. As indicated in FIG. 2B, the current video composition comprises video clips 212, 214, 216, and 218, as well as additional unnumbered clips. FIG. 2B is an enlarged view of region 209 shown in FIG. 2A. The timeline also includes an audio region 211, which displays in graphical form the audio content of a clip displayed in the timeline.

Returning now to the scrubber bar 205 and playhead 206, in normal operation, one can move temporally within a composition by moving playhead 206 along scrubber bar 205, which is preferably accomplished by a click-and-drag operation. Scurbber bar 205 represents a time axis of the media file or composition. Once a location along scrubber bar 205 (i.e., a time within the media file) is selected, the composition may be played from that location, with the video image displayed in monitor 204 and the audio portion played back through a computer's speakers (not shown).

Typically, prior art scrubber bars have been designed so that as the playhead is dragged along the scrubber bar (by a click and drag operation using a mouse, for example), video frames corresponding to the current playhead location in the composition would be displayed in the monitor window. This has allowed a user to locate a particular image of interest in the media file. However, what has not heretofore been possible is to locate a sound of interest within the media file by using the scrubber bar. Prior art systems have not included audio playback to correspond to the user's action of dragging the playhead through the scrubber bar.

Audio scrubbing is a feature that allows a user to easily and accurately find editing locations within a media composition aurally. To select the alternative audio scrubbing mode, a user may, for example, hold an option key, click the mouse button while the cursor is positioned in proximity to playhead 220 (FIG. 2B), which is located in the timeline overlay, and drag right or left to commence audio scrubbing. Dragging right causes forward audio playback. Alternatively, this function could be implemented using playhead 206 in scrubber bar 205. Dragging to the left causes reverse audio playback. This action is also preferably accompanied by the display of images corresponding to the playhead location. Thus both the audio and video portions of the media file corresponding to the current playhead location are played back.

Playback speed is preferably varied during the audio scrubbing operation. In a preferred embodiment, playback speed changes based on displacement of the cursor position from the playhead along the scrubber bar. The farther the mouse is moved, the farther the cursor will move from the playhead location, and the faster the playback speed is. Similarly, in reverse, the farther a user drags the mouse backwards (relative to the time axis), the farther the cursor will move from the playhead location, and the faster playback occurs in a reversed direction.

When a user drags the mouse (in either direction) and variable speed playback begins, the cursor and playhead are temporarily in two different locations. This difference in location is used to calculate the scrubbing playback speed. Initially, the playhead lags behind the new cursor location. The difference in location gets smaller over time because playback causes the playhead to move towards the cursor position. As the difference gets smaller, the speed slows in proportion to the distance between the cursor and playhead. Thus a user can easy locate a particular sound of interest and narrow down its location by slowly moving the playhead back and forth until the desired point is found.

If a user keeps moving the mouse, the playhead will track these movements with a lag. The speed will always be in proportion to the difference in positions. Eventually, if the cursor remains still, the playhead can catch up and cosite with the cursor. As cositing occurs, the speed of playback is slowed to a stop. When the desired location is found, the user lets the mouse button up, and audio scrubbing is ended. The playhead is now located at the position of interest and various editing operations can be performed starting at this location.

As to the speed at which playback occurs, it has been found through empirical testing that the playback speed should be clamped at ±2× the normal speed, regardless of how far the cursor is displaced from the playhead.

While the invention has been disclosed with respect to a limited number of embodiments, numerous modifications and variations will be appreciated by those skilled in the art. It is intended that all such variations and modifications fall with in the scope of the following claims.

1. A method for manipulating a media file using a program having a graphical user interface on a display associated with a computer having access to the file, wherein the graphical user interface comprises a play head moveable to correspond to different locations within the media file, the method comprising:
continuously moving the play head on the graphical user interface from a first location to a second location; and
concurrently with moving the play head, displaying and audibly broadcasting portions of the media file passed by the play head.

2. The method of claim 1, wherein the displayed and audibly broadcast portions of the media file are not contiguous within the file.

3. The method of claim 1, wherein the number of displayed and audibly broadcast portions is inversely proportional to a speed of the movement of the play head.

4. The method of claim 1, further comprising playing the media file at a normal speed starting from the second location after the play head has been moved to the second location.

5. The method of claim 1, wherein the play head is moved backwards.

6. The method of claim 1 wherein the displaying and audible broadcasting are at a variable speed determined in proportion to the distance between the first location and the second location.

7. The method of claim 6 wherein the variable speed is limited to twice a normal playback speed.

8. A method for playing a media file in a player, wherein the player comprises a play head, the method comprising:
dragging the play head; and
concurrently with dragging the play head, displaying and audibly broadcasting portions of the media file that the play head passes.

9. The method of claim 8, wherein the rate of displaying and audibly broadcasting portions of the media file is inversely proportional to a speed of dragging the play head.

10. The method of claim 8, further comprising displaying and broadcasting the media file at a normal speed starting from the frame to which the play head was dragged.

11. The method of claim 8, wherein the play head is dragged backwards.

12. The method of claim 8 wherein the displaying and audible broadcasting are at a variable speed determined in proportion to the distance between the first location and the second location.

13. The method of claim 12 wherein the variable speed is limited to twice a normal playback speed.

14. A computer readable medium, having disposed thereupon program instructions for a computer, the instructions configured to allow the computer to locate and playback a portion of a media file, wherein the locating and playback comprises the steps of:
receiving from a user interface signals corresponding to positioning a cursor over a scrubber bar in a position corresponding to a location of a playhead;
receiving from the user interface signals corresponding to grabbing and moving the playhead along the scrubber bar, wherein the cursor moves at a rate faster than the playhead such that there is a distance separating the playhead and the cursor; and
playing back an audible portion of the media file in response to the movement of the playhead along the scrubber bar.

15. The computer readable medium of claim 14, wherein the rate of playing back an audible portion of the media file is proportional to a distance separating the playhead and the cursor.

16. The computer readable medium of claim 15, wherein the variable speed is limited to twice a normal playback speed.

17. The computer readable medium of claim 14, further comprising displaying and audibly broadcasting the media file at a normal speed starting from a location to which the playhead was dragged.

18. The computer readable medium of claim 14, wherein the play head is dragged backwards.

19. A graphical user interface for a media viewing program executed by a computer, the graphical user interface comprising a scrubber bar, a cursor being movably positionable along the scrubber bar, and a playhead movable along the scrubber bar for indicating a current location in a media file, wherein a playback speed of an audible portion of the media file is determined in proportion to a distance separating the cursor and the playhead along the scrubber bar.

20. The graphical user interface of claim 19 wherein the playback speed is limited to twice a normal playback speed.
